(19) United States
(12) Patent Application Publication
(10) Pub. No.: US 2004/0107076 A1
(43) Pub. Date: Jun. 3, 2004

(54) Method and system for integration of engineering change data

(76) Inventors: Chien-Ming Tseng, Taipei (TW); Chiu-Juan Liu, Taipei (TW); Kuang-Yu Peng, Taipei (TW); Li-Ching Tseng, Taipei (TW); Weng-Chang Chang, Taipei (TW); Sai Wing Young, Taipei (TW)

Correspondence Address: BIRCH STEWART KOLASCH & BIRCH, PO BOX 747, FALLS CHURCH, VA, 22040-0747, US

(21) Appl. No.: 10/404,672

(22) Filed: Apr. 2, 2003

(30) Foreign Application Priority Data
Dec. 3, 2002 (CH) 2002 0427/02

(51) Int. Cl. G06F 17/50

(52) U.S. Cl. 703/1

(57) ABSTRACT

A method and a system for integration of engineering change data are provided. A form generation module searches engineering change data from a database according to search conditions entered by a user via a terminal device and generates accordingly generates an electronic form to which the user modifies the engineering change data. A modification module modifies data of an associated engineering change order with the modified engineering change data. Then, a searching module searches associated engineering change data file from the database according to the search conditions entered by the user. By the above data integration method and system, all related engineering data may be changed in response to modification of any particular engineering data by the user, and associated engineering data can also be searched during the process of searching particular engineering change data.

### FIELD OF THE INVENTION

The present invention relates to methods and systems for integration of engineering change data, and more particularly, to a method and a system for integrating engineering change data applied to product design and fabrication.

### BACKGROUND OF THE INVENTION

The arrival of the era of information technology has accompanied with a ubiquitous utilization of computer devices for aiding the engineers, in the process of product development, design and even fabrication, to perform the jobs of product design and fabrication. This is the so-called Computer Aided Design (CAD) and Computer Aided Manufacturing (CAM). Based on the computer aided tools already equipped in an enterprise, the above mentioned CAD and CAM software has already upgraded from a former 2D system up to a 3D system. In another aspect, the engineers and fabrication departments who are in charge of the product design, fabrication and analysis, has evolved from individual works to an integrated development. For this reason, in order to prevent each engineering department from becoming an information island, the information integration between engineering departments has become an important topic for international simultaneous engineering development.

In the absence of a systematic data management, the first problem to face is the complexity of data searching, since the related engineering key data may be stored in a variety of database systems and the data flow may be very complicated. In particular, when one database retrieved some data from some another database, the original data stored in one database will be changed, therefore, it is very unlikely to guaranty the consistencies between the data in each database. For those engineers who use the stored data to perform product design, development, fabrication and even customer service, if the data they use are not consistent with each other, it must have a severe negative effect on the product manufacture and the customer service.

In the aspect of the engineering design change, a product of consumer electronics may include hundreds or thousands of component parts. In the beginning of such engineering design, a bill of the required material for producing such a product is often listed by the R&D or design engineers, i.e. the Bill of Material (BOM). The content of the BOM includes at least the name, the part number, the quantity and the specification of each of the required component part of the product. However, changes of the content of the BOM is often necessary due to the shortage of component parts in stock, the performance of the component parts or the cost of the component parts. Once the change of the BOM is necessary, i.e. the engineering design change, it must be approved by the related engineering design departments. Otherwise, if the change is approved only by a portion but not all of the design engineers or the department managers, or at least not in a timely manner, disagreements between engineering design departments will be raised, thus the production efficiency and the quality of the product are thus affected.

In another aspect, when a user wishes to search the related data of engineering change, it is often very inconvenient when searching unintegrated data. If the user wishes to modify simultaneously two engineering change data in different levels, other users would not know the existences of data in other levels provided that only the data in one level is searched, not to mention the simultaneous modification of engineering change data in all different levels.

### SUMMARY OF THE INVENTION

In order to overcome the above-mentioned drawbacks in the prior art, a primary objective of the present invention is to provide a method and a system for integration of engineering change data, which allow a user to change simultaneously all the data related to the engineering change data by means of changing only one single engineering order.

Another objective of the present invention is to provide a method and a system for integration of engineering change data, which can search all the other related engineering change data in association with the particular engineering change data.

To achieve the above and other objectives, the present invention proposes a system for integration of engineering change data, including: a database, wherein the data of engineering change order, the data of BOM, the data of electronic forms, the data of the responsible personnel and departments for processing the engineering change data, and the production engineering data are stored; a form generation module, wherein an electronic form is generated on the screen of the electronic data processing system based on the resultant data of the electronic form retrieved from the database by using some proper searching criteria in the electronic data processing system; a modification module, wherein the engineering change data, corresponding to those searched from the database, is modified based on the engineering data entered by the user into the electronic data processing system; and a searching module, wherein the data in association with the related engineering data change is searched from the database based on the searching criteria entered by the user into the electronic data processing system.

The method for integration of engineering change data through the system for integration of engineering change data includes the following steps. First, the form generation module generates an electronic file of engineering change order based on the engineering change data retrieved from the database according to the searching criteria entered by the user through a electronic data processing system. The user of which can thus enter the engineering change data. Next, the modification module changes the content of the engineering change order related to that particular engineering change data based on the engineering change data entered by the user. Then, the searching module searches the related data file of engineering change from the database and made available to the user based on the searching criteria entered by the user.

In comparison with the method and the system for integration of engineering change data of the prior art, the present invention of a method and a system for integration of engineering change data provides the user with a mean to change all the other related engineering data by only changing one engineering data. Moreover, the engineering data in association with the particular engineering change data may also be searched.

### BRIEF DESCRIPTION OF THE DRAWINGS

The present invention can be more fully understood by reading the following detailed description of the preferred embodiments with reference made to the accompanying drawings, wherein:

FIG. 1 is a block diagram showing application structure of a system for integration of engineering change data according to the invention;

FIG. 2 is a block diagram showing system structure of the system for integration of engineering change data according to the invention; and

FIG. 3 is a flow diagram showing procedural steps for performing a method for integration of engineering change data according to the invention.

### DETAILED DESCRIPTION OF PREFERRED EMBODIMENTS

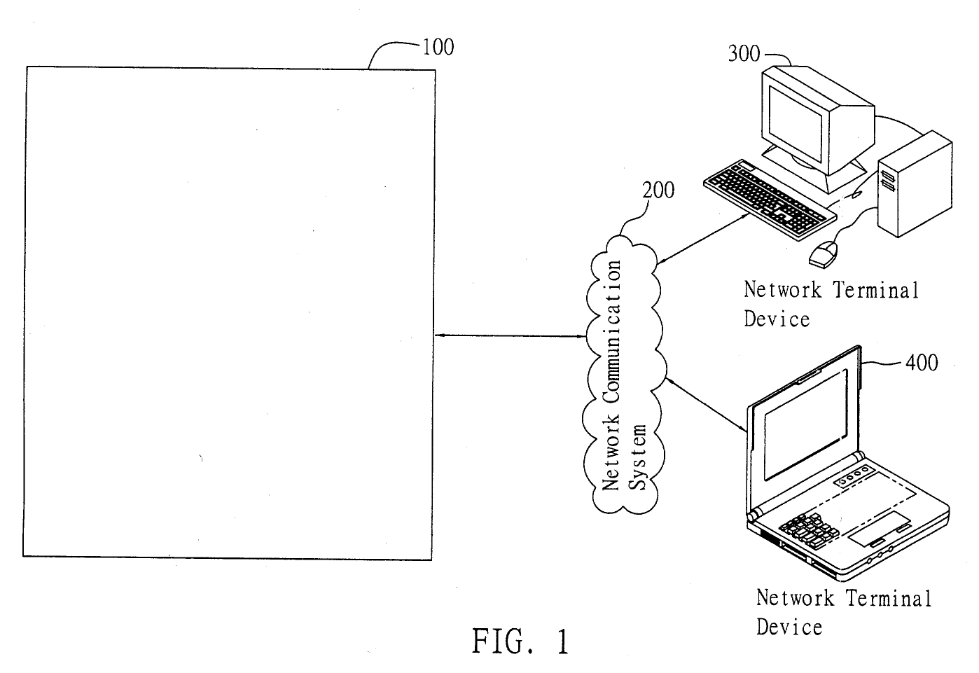

In FIG. 1, in this particular embodiment, the present invention of a system for integration of engineering change data 100 is applied on a network communication system 200 with a client-server structure. The system for integration of engineering change data 100 is constructed on a server-end of the network communication system. The client-end user can use a browser application program on the network terminal device 300 and the network terminal device 400, which are capable of connecting with a network, to connect with the system for integration of engineering change data 100 constructed on the server-end. And, to transfer and receive the data including the related data for integration of engineering change data. The network communication system 200 can be an Internet, an Intranet or an Extranet. The network terminal device 300 and the network terminal device 400 may be a personal computer (PC), a notebook computer (NB) or a workstation. The browser application program may be the Internet Explorer of the Microsoft company or the Netscape Navigator of the Netscape company. The network communication system 200 with a client-server structure described above, the network terminal device and the browser application program are the software and hardware structure of the prior art, the discussion of which is thus neglected.

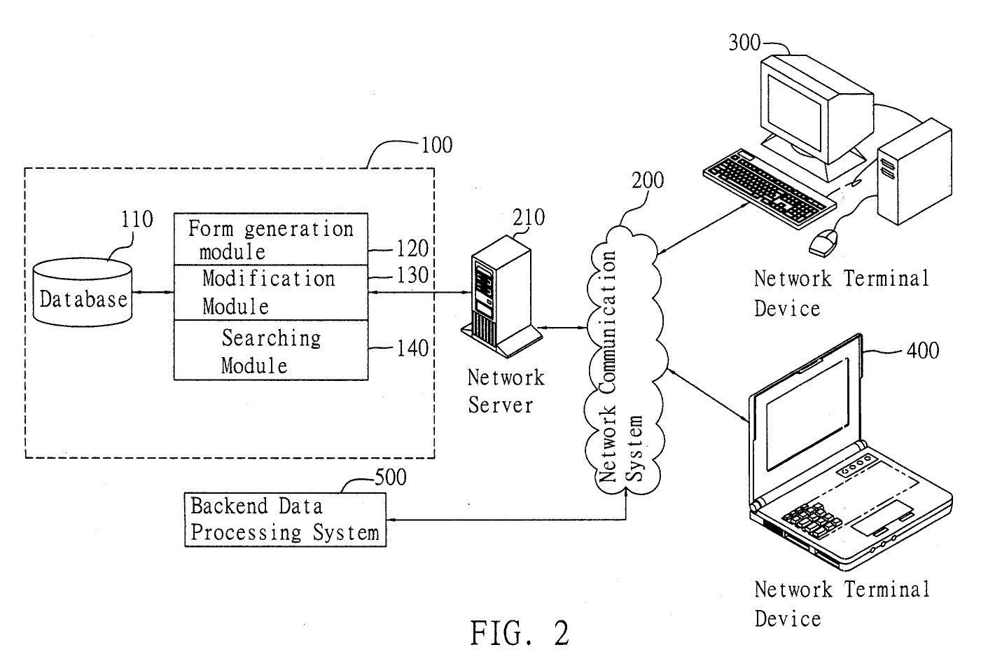

In FIG. 2, wherein the system structure of the present invention of a system for integration of engineering change data is shown. As shown in the figure, the system for integration of engineering change data 100 works in accompany with a network server 210, which enables the mutual communication between the system for integration of engineering change data and the network terminal device 300 and the network terminal device 400 via the network communication system 200. The network server 210 also responds the user commands or other needs for data access to the network terminal device 300 and the network terminal device 400. In this particular embodiment. the network terminal device 300 and the network terminal device 400 use the network browser application program built on them, such as the Internet Explorer of the Microsoft company or the Netscape Navigator of the Netscape company, to connect with the system for integration of engineering change data 100 by using the network server 210 via the network communication system 200 and to transfer, to receive and to access the data of related engineering change. Moreover, the system for integration of engineering change data 100 also connects with a back-end data processing system 500 through the network communication system 200. Within the back-end data processing system 500, the related data of material list generated from the system for integration of engineering change data 100 is stored. In this particular embodiment, the back-end data processing system 500 may be an Enterprise Resource Planning (ERP) or a Material Resource Planning (MRP).

The system for integration of engineering change data 100 includes a database 110, a form generation module 120, a modification module 130 and a searching module 140.

The database 110 provides the system for integration of engineering change data 100 to store the data entered through a network terminal device through the network communication system 200 including the data of the engineering change order, the data of BOM, the data of electronic forms, the data of the responsible personnel and departments for processing the engineering change data, the data of standard operation procedure and the production engineering data. The data of the engineering change order includes at least the data fields of the proposer of the engineering design change, the content of the engineering design change, the corresponding personnel or departments of the engineering change order after the engineering design change. The data of BOM includes at least the data fields of the names of the necessary component parts, the part number, and the specifications and the quantity. The electronic form data includes at least the data fields of the serial number of each electronic form and the file in the format of electronic form. The data of the responsible personnel and departments for processing the engineering change data includes at least the name, the title, the employee number, the e-mail, and the department name of the responsible personnel and departments for processing the engineering change data. The data of standard operation procedure includes at least the data fields of the standard operation procedure of the related R&D, fabrication and testing departments of the corresponding engineering change order. The production engineering data includes at least the data fields of the related production flow of the corresponding engineering change data. Through the establishment of such kind of associative database, the system for integration of engineering change data 100 can quickly find the corresponding data when the user enters any one of the above data. Notice that each data fields and its corresponding data form described above is for exemplary purposes only, more specific and detailed content depends on the real situations. Moreover, the data fields may contain other data fields or data lists, however, only those parts related to the processing of integration of engineering change data are disclosed for simplicity and clarity. On the other hand, there is a plurality of system structures for the associative database, the establishment of which is of prior art, the discussion of which is thus neglected.

The form generation module 120 searches the electronic form data from the database 110 that match the searching criteria of the electronic form and the user priority limit based on the electronic form search data and the user identification data entered by the user through the network terminal device. According to which, an electronic form is shown on the display unit of the network terminal device, such that the content of the electronic form related to the engineering change data may be entered through the input unit, such as a keyboard or a mouse, of a network terminal device. In this particular embodiment, the electronic form of engineering change may be the component parts change notification, the product change notification and the engineering change notification. Moreover, after the related engineering change data has been entered and confirmed by the user, the engineering change data will be stored into the database 110 and into the back-end data processing system 500, if necessary.

The modification module 130 modifies the corresponding engineering change data based on the engineering change data entered through the electronic form generated by the generation module 120 through a network terminal device and searched from the database 110. The related engineering change data entered by the user through the network terminal device is then compared with the other related engineering change data stored in the database 110. When there is any change in the content of the engineering data, the engineering data is thus changed and the version of the engineering data is thus updated. In this particular embodiment, if the electronic form of the component parts change notification described above is sent in order to change the engineering data, the modification module 130 then searches the content of the corresponding BOM and the document file of the component parts notification to perform the changes in the engineering data.

The searching module 140 searches the related engineering change data matching the searching criteria entered by the user through a network terminal device so that the user can consult the associated data. In this particular embodiment, when the component parts of a product, in its process of design and development, on the BOM needs to be changed due to the shortage of component parts in stock, the performance of the component parts or the cost of the component parts, at least one of the engineering change notification will be sent. There is at least one working item corresponding to each engineering change notification; and at least a material list change notification corresponding to different or same working item; and various material change notification corresponding to different or same material list change notification. The various engineering change data and their processing flow under the condition of the above mentioned design and development process may be regarded as having a relation between different levels. The searching module 140 searches the upper or lower levels of the engineering change data from any of the above mentioned engineering change data as a center. Moreover, when a designer wishes to change any engineering data, a component part change notification described above will be filled, the product change notification or the engineering change order will also be sent before or after the mass production. While the user is searching the component parts change notification, the searching module 140 may also search the product change notification or engineering change order of the corresponding component parts change notification so that the search of engineering change data may be in parallel levels.

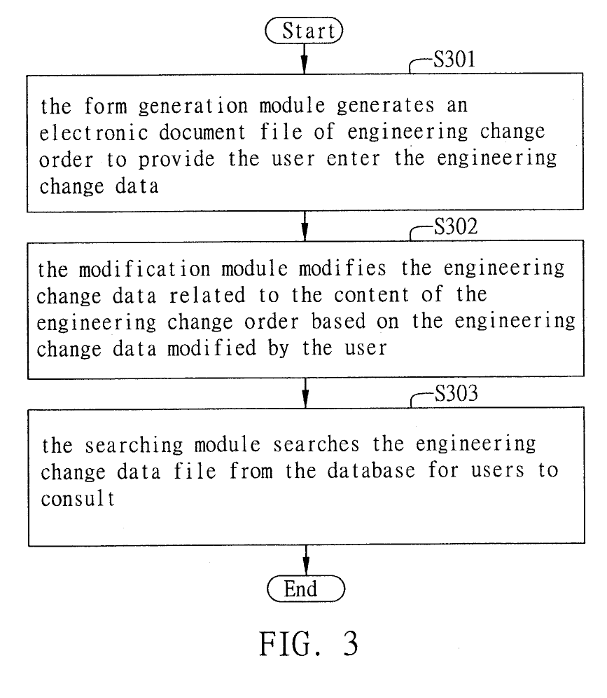

In FIG. 3, wherein the flow steps of the present invention of a method for integration of engineering change data is shown.

In step S301, the form generation module 120 searches the engineering change data from the database 110 that on the searching criteria entered through the network terminal device and generates an electronic file of the engineering change order so that the user may enter the related engineering change data. In this particular embodiment, if the user wishes to change the engineering data before mass production, the data of the product, such as the product name or the serial number, and the data of identification, such as the user name or the employee number, are entered through the network terminal device. After such data is received by the form generation module 120 the corresponding data is searched from the database 110 so that an appropriate electronic form of engineering change for the component parts change notification and the product change notification may be generated. The electronic form is then sent to the network terminal device of the user via the network communication system 200, so that the user may edit and modify the engineering data through the network terminal device, then proceed to step S302.

In step S302, the modification module 130 modifies the engineering change order related to the engineering change data enter by the user. As described above, after the related engineering data, such as the component parts change notification and product change notification, has been changed, the modification module 130 then searches the database 110 to find the BOM, the document files. the incoming material check card, the standard operation procedure and the production engineering notification corresponding to the component parts notification and the product change notification. The same content of the parts edited or modified by the user is also changed. Through the modification mechanism of the modification module 130, the user does not need to change the related engineering order one-by-one. Thus, there would not have an error in the modification or forget to change any part. The content after modification is defined as a newer version of component parts change notification and product change notification while the one before modification is an older version. Nonetheless, both versions are stored in the database 110 and/or the back-end data processing system 500 so that the user can consult if necessary, then proceed to step S303.

In step S303, the searching module 140 searches the related engineering change file from the database 110 based on the searching content entered by the user so that the user may consult, wherein the related engineering change file includes at least the engineering change data in various engineer levels. As described above, if the user wishes to search and overlook the modified engineering change data. the user only needs to enter the related data of engineering change order, such as the order number, modification data or the modifier, to search and to overlook via the network terminal device. After the searching module 140 received the searching criteria, the engineering change data that matches the searching criteria is then searched from the database 110. In this particular embodiment, when it happens to change the content of the component parts in the BOM, at least one of the engineering change notification will be sent; there is at least one working item corresponding to various engineering change notification; there is at least one material list change notification corresponding to different or same working item; there is also various material list change notification corresponding to various material list change. Meanwhile, the user may first searches the material list change notification, and further associatively searches the engineering change data, such as the condition content, the engineering change notification, the working item, and the material change notification, from the database 110 that matches the material list change notification. On the other hand, the user may change the component parts change notification and the product change notification through the modification module 130. Then the searching module 140 provides the user to search the product change notification from the component parts change notification. The component parts change notification may also be searched from the product change notification, etc. Further, the user may search the BOM, the document file, the incoming material check card, the standard operation procedure and the product engineering notification related to the component parts change notification and the product change notification.

In summary, the present invention of a method and a system for integration of engineering change data may provide the user a mean to change all other related engineering data by changing only one engineering data. Furthermore, it may find the related engineering change data in the process of data searching.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for integration of engineering change data for allowing a user to integrate engineering change data via a network terminal device and a network communication system, the method comprising the steps of:
having a form generation module search engineering change data from a database corresponding to search conditions and user identification data entered by the user via the network terminal device and accordingly generate an engineering change order electronic form by which the user modifies the engineering change data;
having a modification module modify data of an associated engineering change order with the engineering change data modified by the user and store the modified data in the database, as well as send the engineering change data to a back-end data processing system for data management depending on the user's requirement; and
having a searching module search an associated engineering change data file from the database according to the search conditions entered by the user, wherein the engineering change data file comprises engineering change data of different engineering stages.

2. The method of claim 1, wherein the network terminal device is a workstation, personal computer, notebook compute, palm computer, personal digital assistant (PDA), or cellular phone.

3. The method of claim 1, wherein the network communication system is Internet, Intranet, or Extranet.

4. The method of claim 1, wherein the network communication system is a cable or wireless communication system.

5. The method of claim 1, wherein the back-end data processing system is an Enterprise Resource Planning (ERP) system or a Material Resource Planning (MRP) system.

6. The method of claim 1, wherein the engineering change data comprise a component parts change notification, a product change notification, or an engineering change notification.

7. The method of claim 1, wherein the modified data of the associated engineering change order comprise material report data, a document file, an incoming material check card, a standard operation procedure, or a production engineering notification.

8. The method of claim 1, wherein the database is an associative database.

9. A system for integration of engineering change data for allowing a user to integrate engineering change data via a network terminal device and a network communication system, the integration system comprising:
a database for storing at least engineering change order data, material report data, electronic form data, data of responsible units for processing engineering change orders, standard operation procedures, and production engineering data;
a form generation module for searching electronic form data from the database corresponding to search conditions entered by the user via the network terminal device to accordingly generate and display an electronic form on the network terminal device via the network communication system to which electronic form the user enters engineering change data via the network terminal device;
a modification module for modifying data of an associated engineering change order with the entered engineering change data from the user and storing the modified data in the database, as well as sending the engineering change data to a back-end data processing system for data management depending on the user's requirement; and
a searching module for searching an associated engineering change data file from the database according to the search conditions entered by the user.

10. The system of claim 9, wherein the network terminal device is a workstation, personal computer, notebook compute, palm computer, personal digital assistant (PDA), or cellular phone.

11. The system of claim 9, wherein the network communication system is Internet, Intranet, or Extranet.

12. The system of claim 9, wherein the network communication system is a cable or wireless communication system.

13. The system of claim 9, wherein the back-end data processing system is an Enterprise Resource Planning (ERP) system or a Material Resource Planning (MRP) system.

14. The system of claim 9, wherein the engineering change data comprise a component parts change notification, a product change notification, or an engineering change notification.

15. The system of claim 9, wherein the modified data of the associated engineering change order comprise material report data, a document file, an incoming material check card, a standard operation procedure, or a production engineering notification.

16. The system of claim 9, wherein the database is an associative database.
